(19) United States
(12) Patent Application Publication
(10) Pub. No.: US 2025/0211108 A1
(43) Pub. Date: Jun. 26, 2025

(54) POWER CONVERTER AND CURRENT COMPARISON CIRCUIT

(71) Applicant: Joulwatt Technology Co., Ltd., Hangzhou (CN)

(72) Inventors: Pitleong WONG, Hangzhou (CN); Li XU, Hangzhou (CN)

(21) Appl. No.: 19/001,536

(22) Filed: Dec. 25, 2024

(30) Foreign Application Priority Data
Dec. 25, 2023 (CN) 202311801335.9
Dec. 25, 2023 (CN) 202410671561.8

(51) Int. Cl. H02M 3/157; H02M 1/00; H02M 1/08; H02M 3/158

(52) U.S. Cl. CPC H02M 3/157; H02M 1/0009; H02M 1/08; H02M 3/158

(57) ABSTRACT

The present application provides a power converter and a current comparison circuit, in which a judgment module and a selector are set to select one of the inductor current detection signal or the current reconstruction signal with a predetermined slope of the power converter according to the DC input voltage and DC output voltage of the power converter as a detection signal, and a comparison signal for adjusting the duty cycle of the switching control signal of the power converter is generated by comparing the detection signal with the first reference voltage, so that the inductor current information of the system can be accurately obtained under different duty cycles of the switching control signal, which facilitates accurate control of the system and improves output quality, and is easy to implement and cost-effective.

### CROSS-REFERENCE TO RELATED APPLICATION

This application claims priority to Chinese patent application of invention No. 202311801335.9 filed on Dec. 25, 2023, entitled “CURRENT ERROR CIRCUIT FOR POWER CONVERTER”, and Chinese patent application of invention No. 202410671561.8 filed on May 28, 2024, entitled “POWER CONVERTER AND CURRENT ERROR CIRCUIT”, the contents of which are incorporated herein by reference, including the full text of the specification, claims, drawings and abstract.

### TECHNICAL FIELD

The present application relates to the technical field of integrated circuit, more particularly, to a power converter and a current comparison circuit.

### BACKGROUND

Power supply is an indispensable component of various electronic devices, and its performance directly affects the technical indicators of electronic devices and whether they can work safely and reliably. Currently, the mainstream application is switch mode power supply. Switch power mode supply, also known as switch converter or power converter, is a type of power supply that uses modern power electronics technology to adjust the conduction ratio or frequency of switch devices to maintain constant output voltage or current. Switch mode power supplies have the characteristics of small size, good stability, and high conversion efficiency compared to traditional linear power supplies. Therefore, they are widely used in occasions of chargers, power adapters, LED driver power supplies, wireless communication devices, LCD screen power management, electronic refrigerators, and Ethernet power supplies.

The control circuit in the power converter comprises a switch transistor driving unit for providing switching control signals. In a single loop control circuit, the error signal generated by the voltage loop is compared with the sawtooth wave to control the duty cycle of the switching control signal of the power converter. In a dual loop control circuit, the detection signal of the inductor current is obtained through the current loop, and the error signal of the voltage feedback signal is obtained through the voltage loop. The error signal is used to control the peak current of the inductor current and thus control the duty cycle of the switching control signal of the power converter. Therefore, in the control mechanism of power converters, accurately determining the inductance current of the system is one of the important factors affecting system quality.

### SUMMARY

In order to solve the above technical problems, the present application provides a power converter and a current comparison circuit, so as to accurately obtain the inductance current information of the system under different duty cycles of the switching control signal, achieve accurate control of the system, and improve output quality.

In a first aspect of the present application, a current comparison circuit for power converter is provided, comprising:
a judgment module, used to generate a selection signal according to a DC input voltage and a DC output voltage of the power converter;
a current reconstruction module, used to generate a current reconstruction signal with a predetermined slope;
a selector, used to select one of an inductor current detection signal of the power converter or the current reconstruction signal as a detection signal according to the selection signal; and
a first comparator, used to compare the detection signal with a first reference voltage to generate a comparison signal,
wherein, the comparison signal is used to adjust duty cycle of a switching control signal of the power converter.

Optionally, the judgment module determines whether the on time of the switching control signal is less than a predetermined time value according to the DC input voltage and the DC output voltage,
when the on time is less than the predetermined time value, the selection signal is used to select the current reconstruction signal as the detection signal,
when the on time is greater than or equal to the predetermined time value, the selection signal is used to select the inductor current detection signal as the detection signal.

Optionally, the switching control signal has a fixed switching cycle, the judgment module obtains a conversion ratio of the power converter according to the DC input voltage and the DC output voltage, and determines whether the on time of the switching control signal is less than a predetermined time value according to the conversion ratio.

Optionally, the switching control signal has a varied switching cycle, the judgment module obtains a conversion ratio of the power converter according to the DC input voltage and the DC output voltage, and determines whether the on time of the switching control signal is less than a predetermined time value according to the conversion ratio and the switching cycle.

Optionally, when the on time is less than the predetermined time value, the selection signal is further used to enable the minimum off time limit of the switching control signal,
when the on time is greater than or equal to the predetermined time value, the selection signal is also used to enable the minimum on time limit of the switching control signal.

Optionally, the judgment module comprises:
a comparison module, used to determine whether the conversion ratio of the power converter is less than a predetermined value according to the relationship between the DC input voltage and the DC output voltage.

Optionally, the comparison module comprises:
a first resistor network, used to obtain a proportional signal of the DC input voltage according to a predetermined proportional coefficient, and the proportional coefficient is equal to a predetermined value of the conversion ratio;
an error amplifier, used to amplify an error between the DC output voltage and the proportional signal of the DC input voltage to generate an error signal; and
a second comparator, used to compare the error signal with a second reference voltage to generate the selection signal,
wherein, the second reference voltage is greater than or equal to zero voltage; when the second reference voltage is greater than zero voltage, the second reference voltage is used to increase the predetermined value of the conversion ratio to achieve hysteresis control.

Optionally, the comparison module comprises:
a divider, used to divide the DC output voltage by the DC input voltage to obtain a voltage signal representing the proportional coefficient; and
a third comparator, used to compare the voltage signal representing the proportional coefficient with a third reference voltage to generate the selection signal.

Optionally, the comparison module comprises:
a divider, used to divide the DC output voltage by the DC input voltage to obtain a voltage signal representing the proportional coefficient;
a time-to-voltage module, used to convert the switching cycle of the switching control signal into a voltage signal representing the switching cycle;
a multiplier, used to multiply the voltage signal representing the proportional coefficient with the voltage signal representing the switching cycle to obtain the voltage signal representing the on time; and
a fourth comparator, used to compare the voltage signal representing the on time with a fourth reference voltage to generate the selection signal.

Optionally, the comparison module comprises:
a voltage controlled current source, used to convert the DC input voltage into an output current of the voltage controlled current source;
a capacitor and a switch connected in parallel with each other, the voltage controlled current source is connected to the capacitor to charge the capacitor, and the switch discharges the capacitor periodically under the control of a clock signal, to generate a proportional signal of the DC input voltage on the capacitor;
a fifth comparator, used to compare the DC output voltage with the proportional signal of the DC input voltage generated on the capacitor to generate the selection signal; and
a latch, used to latch the selection signal under the control of the clock signal.

Optionally, the voltage controlled current source comprises:
a second resistor network, used to obtain a proportional signal of the DC input voltage;
a current mirror, comprising a first current path and a second current path coupled to each other,
a transistor and a first resistor, connected in series at the first current path of the current mirror; and
an operational amplifier, wherein the positive input terminal of the operational amplifier receives the proportional signal of the DC input voltage obtained by the second resistor network, and the negative input terminal is connected to the intermediate node between the transistor and the first resistor, and the output terminal is connected to the control terminal of the transistor,
wherein, the second current path of the current mirror provides the output current of the voltage controlled current source.

Optionally, the resistance value of the first resistor is equal to the resistance value of a configuration resistor of the power converter, and the configuration resistor is used to set the operating switching cycle of the power converter.

In a second aspect of the present invention, a power converter is provided, comprising:
a power stage circuit;
the current comparison circuit according to any embodiment of the present application, used to obtain a comparison signal of inductor current, and the comparison signal is used to adjust the duty cycle of the switching control signal of the power converter;
a logic and driving circuit, to receive the comparison signal output by the current comparison circuit, to output a switching control signal according to the comparison signal to control the on/off states of a main switch transistor in the power stage circuit.

The advantageous effects of the present application at least comprise:

In the process of comparing the detection signal with the first reference voltage to generate a comparison signal to adjust the duty cycle of the switching control signal of the power converter, embodiments of the present application use the DC input voltage and DC output voltage of the power converter to select one of the inductor current detection signal or the current reconstruction signal with a predetermined slope as the detection signal of the power converter. Compared with the current solution, since the duty cycle status of the switching control signal of the power converter in each switch cycle can be determined according to the DC input voltage and DC output voltage of the power converter, the present application can select the appropriate source of the detection signal under different duty cycle conditions, so that the inductor current information of the system can be accurately obtained under different duty cycles of the switching control signal, easy to achieve accurate control of the system and improve output quality, while is also easy to implement and cost-effective.

It should be noted that the above general description and the later detailed description are merely exemplary and illustrative, rather than restricting the present application.

### BRIEF DESCRIPTION OF THE DRAWINGS

FIG. 1 shows a schematic diagram of structure of a power converter;

FIG. 2 shows a circuit schematic diagram of a ramp current construction circuit;

FIG. 3A shows a waveform diagram of the inductor current signal in FIG. 1;

FIG. 3B shows another waveform diagram of the inductor current signal in FIG. 1;

FIG. 4 shows a schematic view of structure of the power converter provided by the embodiments of the present application;

FIG. 5 shows another schematic diagram of structure of the power converter provided by the embodiments of the present application;

FIG. 6 shows a waveform schematic diagram of the inductor current signal in FIGS. 4 and 5;

FIG. 7 shows another waveform schematic view of the inductor current signal in FIGS. 4 and 5;

FIG. 8 shows a block diagram of structure of the judgment module provided by the first embodiment of the present application;

FIG. 9 shows a block diagram of structure of the judgment module provided by the second embodiment of the present application;

FIG. 10 shows a block diagram of structure of the judgment module provided by the third embodiment of the present application;

FIG. 11 shows a block diagram of structure of the judgment module provided by the fourth embodiment of the present application;

FIG. 12 shows a block diagram of structure of the voltage controlled current source in FIG. 11.

### DETAILED DESCRIPTION

In order to facilitate understanding the present application, a more comprehensive description of the present application will be provided below with reference to the relevant accompanying drawings. Preferred embodiments of the present application are given in the accompanying drawings. However, the present application can be implemented in different forms and is not limited to the embodiments described herein. On the contrary, the purpose of providing these embodiments is to make the understanding of the disclosure of the present application more thorough and comprehensive.

The phrases of reference to “one embodiment” or “some embodiments” described in this specification mean that specific features, structures, or characteristics described in conjunction with that embodiment are included in one or more embodiments of the present application. Therefore, the statements such as “in one embodiment”, “in some embodiments”, “in some other embodiments”, etc. appearing differently in this specification do not necessarily refer to the same embodiments, but rather imply “one or more but not all embodiments”, unless otherwise specifically emphasized. The terms of “including”, “comprising”, “have”, and their derivatives all mean “including but not limited to”, unless otherwise specifically emphasized.

In the description of this application, words such as “exemplary” or “for example” are used to indicate examples, illustrations, or clarifications. Any embodiments described as “exemplary” or “for example” in this application should not be interpreted as more preferred or advantageous than other embodiments. In this description, “and/or” is a description of the association relationship between related objects, indicating that there can be three types of relationships, for example, A and/or B, which can represent: only A exists, A and B exist at the same time, and only B exists. “Multiple” refers to two or more. In addition, in order to facilitate clear description of the technical solution of the embodiments of the present application, words such as “first” and “second” are used to distinguish similar or identical items with similar functions and effects. Those skilled in the art can understand that the words “first” and “second” do not limit the quantity and execution order, and the words “first” and “second” do not necessarily define differently.

In addition, the same reference numerals in the accompanying drawings indicate the same or similar structures, so they are not described repeatedly. That is, the various parts in this specification will be described in a combination of parallel and progressive ways, with each part focusing on its differences from other parts. The same or similar parts among each part can be referred to each other.

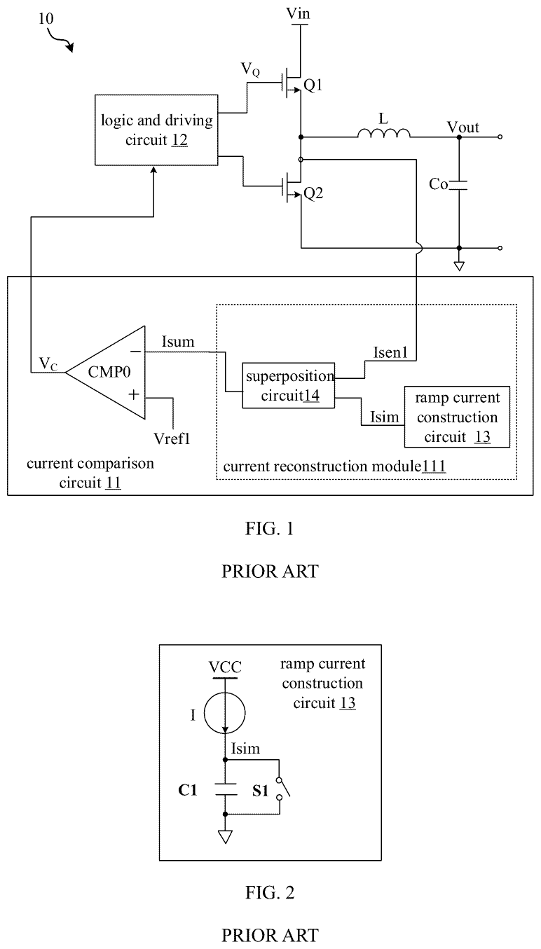

FIG. 1 shows a schematic diagram of structure of a power converter in related technology. The power converter 10 adopts a BUCK topology structure, which comprises a main switch transistor Q1, an inductor L connected to the main switch transistor Q1, a synchronous rectifier transistor Q2, and an output capacitor Co. The power converter 10 receives an input signal Vin, which is converted by the main switch transistor Q1 to output a DC output signal Vout to supply to the load. The voltage at the two ends of the output capacitor Co is referred to as the output voltage signal Vout.

As shown in FIG. 1, the control circuit of power converter 10 comprises a current comparison circuit 11 and a logic and drive circuit 12. The current comparison circuit 11 comprises a current reconstruction module 111 and a comparator CMP0; the current reconstruction module 111 comprises a ramp current construction circuit 13 and a superposition circuit 14. The structure of the ramp current construction circuit 13 is as shown in FIG. 2, comprising a current source I, a capacitor C1, and a switch S1. The current source I is used to charge capacitor C1, and switch S1 is controlled by the inverse signal of the control signal V_{Q} of the main switch transistor Q1 and has the opposite switching state to the main switch transistor Q1, used to discharge the capacitor C1 in the conduction state.

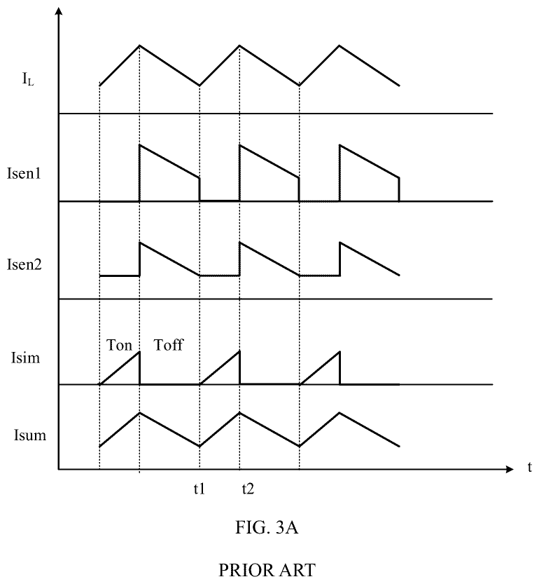

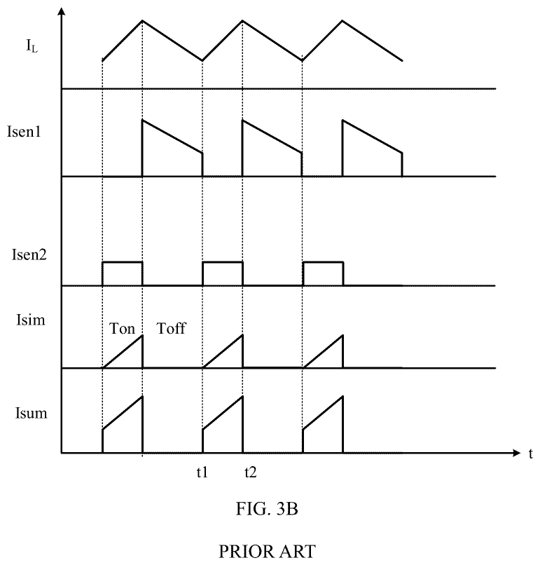

Refer to FIGS. 3A and 3B, it can be seen that during the on time period Ton of the main switch transistor Q1, the switch S1 is turned off, and the current source I charges the capacitor C1. The ramp current construction circuit 13 outputs a ramp current construction signal Isim of which the slope can characterize the rising slope of the rising phase of the inductor current IL; during the off time period Toff of the main switch transistor Q1, sample to obtain the inductor current detection signal Isen1 during the decreasing phase of the inductor current IL. The superposition circuit 14 receives the ramp current construction signal Isim and the directly samples the obtained inductor current detection signal Isen, and performs arithmetic processing on the two to output the inductor current reconstruction signal Isum. Specially, the superposition circuit 14 in FIG. 1 can generate an intermediate signal Isen2 according to the inductor current detection signal Isen1, and then superimposes the intermediate signal Isen2 with the ramp current construction signal Isim to output the inductor current reconstruction signal Isum. Refer to FIG. 3A, the superimposition circuit 14 is set with an intermediate signal Isen2, which is equal to the inductor current detection signal Isen1 in the off time period Toff of the main switch transistor Q1, and is equal to the value of the inductor current detection signal Isen1 at the end time of the off time period of the main switch transistor Q1 within the on time period Ton of the main switch transistor Q1, and finally obtains the inductor current reconstruction signal Isum characterizing the inductor current information within the entire switch cycle. Refer to FIG. 3B, the superposition circuit 14 is set with an intermediate signal Isen2, which is equal to the value of the inductor current detection signal Isen1 at the end time of the off time period of the main switch transistor Q1 within the on time period Ton of the main switch transistor Q1, and finally obtains the inductor current reconstruction signal Isum characterizing the inductor current information within the on time period Ton of the main switch transistor Q1 of a switching cycle. Those skilled in the art know that according to the topology of the power converter, the current amplitude of the current source I is set to be related to the input and/or output voltage, so it can obtain that the slope of the ramp current construction signal Isim is in proportion to the rising slope of the inductor current, and thus it can represent the information of the inductor current.

The comparator CMP0 in the power converter 10 receives the inductor current reconstruction signal Isum and a reference signal Vref1 to obtain a comparison signal Vc, which is used to control the switching status of the main switch transistor Q1 in the power stage circuit 10. The logic and driving circuit 12 receives the comparison signal Vc and a clock signal output from the comparator, so as to output a switching control signal V_{Q} to control the on/off state of the main switch transistor Q1 according to the comparison signal Vc and the clock signal.

As shown in FIGS. 3A and 3B, in the operation mode of continuous conduction, e.g., at time t1, the inductor current IL is at the end of the off time, and its valley value can be obtained by the intermediate signal Isen2 at this time. Then, during the on time, such as the time period from t1 to t2, the ramp current construction circuit 13 outputs a ramp current construction signal Isim, and by superimposing the ramp current construction signal Isim on the intermediate signal Isen2 denoting the valley value inductor current detection signal Isen within the time period from t1 to t2, the inductor current reconstruction signal Isum at least denoting the information of the inductor current within the on time period Ton of the main switch transistor Q1 can be obtained.

However, when the duty cycle of the control signal V_{Q} of the main switch transistor Q1 is relatively large, the off time of the main switch transistor Q1 in each switching cycle is relatively short, meanwhile due to the influence of the noise of the main switch transistor Q1, certain blanking time needs to be set after the main switch transistor Q1 is turned on or off before sampling, which may result in insufficient time to obtain the valley value of the inductor current IL during the off period of the main switch transistor Q1, thus easily causing deviation in the reconstructed current and affecting the output quality of the system.

For the above problems, the present application provides a new power converter structure that determines the duty cycle of the switching control signal of the power converter in each switching cycle according to the DC input voltage and DC output voltage of the power converter, so as to select an appropriate detection signal source under different duty cycle conditions; for example, it selects to compare the inductor current detection signal obtained at least by sampling the inductor current during the on period of the main switch transistor with the reference voltage when the duty cycle is large to generate a comparison signal for adjusting the duty cycle of the switching control signal of the power converter; or, it selects to compare the current reconstruction signal with the reference voltage when the duty cycle is small, to generate a comparison signal for adjusting the duty cycle of the switching control signal of the power converter, so that the inductance current information of the system can be accurately obtained under different duty cycles of the switching control signal. This facilitates accurate control of the system and improves output quality, and is easy to implement and cost-effective.

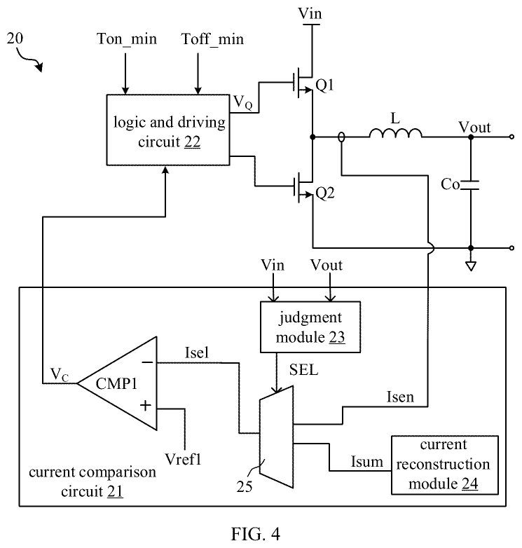

FIG. 4 shows a schematic diagram of structure of a power converter provided in an embodiment of the present application. The power converter 20 comprises: a power stage circuit, a current comparison circuit 11, and a logic and drive circuit 22. Of course, the power converter 20 may also comprise some other devices for implementing conversion of input/output power, which are not shown in the relevant drawings since they are not directly related to the technical solution of the present application.

In the example shown in FIG. 4, the power converter 20 adopts a BUCK topology structure, and its power stage circuit comprises: a main switch transistor Q1, an inductor L connected to the main switch transistor Q1, a rectifier Q2, and an output capacitor Co. The power converter 20 receives the input signal Vin, and outputs a DC output signal Vout to supply to the load through the switching conversion of the main switch transistor Q1. The voltage across the output capacitor Co is referred to as the output voltage signal Vout.

The current comparison circuit 21 receives the DC input voltage Vin and the DC output voltage Vout of the power converter 20, and is used to obtain the comparison signal Vc of the inductor current according to the DC input voltage Vin and the DC output voltage Vout, wherein the comparison signal Vc is used to adjust the duty cycle of the switching control signal V_{Q} of the power converter 20.

The logic and driving circuit 22 receives the comparison signal Vc output by the current comparison circuit 21, and outputs a switching control signal V_{Q} to the control terminal of the main switch transistor Q1 according to the comparison signal Vc to control the on/off states of the main switch transistor Q1.

In this embodiment, refer to FIG. 4, the current comparison circuit 21 specifically comprises: a judgment module 23, a current reconstruction module 24, a selector 25, and a first comparator CMP1. The judgment module 23 is used to generate a selection signal SEL according to the DC input voltage Vin and DC output voltage Vout of the power converter 20; the current reconstruction module 24 is used to generate a current reconstruction signal Isum with a predetermined slope; the first input terminal of selector 25 receives the inductor current detection signal Isen, and the second input terminal receives the current reconstruction signal Isum, and the selection control terminal receives the selection signal SEL. Selector 25 is used to select one of the inductor current detection signal Isen of power converter 20 or the current reconstruction signal Isum as the detection signal Isel according to the selection signal SEL; the first input terminal of the first comparator CMP1 receives the detection signal Isel, and the second input terminal receives the first reference voltage Vref1. The first comparator CMP1 is used to compare the detection signal Isel with the first reference voltage Vref1 to generate the comparison signal Vc.

In specific implementation, the inductor current detection signal Isen can be obtained by directly sampling the inductor current during the on time period of the main switch transistor Q1 in one switching cycle, or can be obtained by directly sampling the inductor current within the entire switching cycle; and optionally, the inductor current detection signal Isen can be a voltage signal or a current signal.

The specific implementation structure and principles of the current reconstruction module 24 generating the current reconstruction signal Isum can be understood by referring to existing technical solutions, as long as the generated current reconstruction signal Isum can characterize the information of the inductor current of the on time period Ton of the main switch transistor Q1 within one switching cycle.

The selector 25, e.g., selects one of the inductor current detection signal Isen or the current reconstruction signal Isum for output according to the different level states of the selection signal SEL. For example, when the selection signal SEL is in the first level state (e.g., one of logic high level and logic low level), the inductor current detection signal Isen is selected for output; when the selection signal SEL is in the second level state (such as the other of logic high level and logic low level), the current reconstruction signal Isum is selected for output. Optionally, selector 25 can be a conventional device or module that can achieve an either-or output, such as a single-pole double-throw switch or a transistor switch array.

In the example shown in FIG. 4, the judgment module 23 is configured to judge whether the on time (such as logic high level time, marked as Ton) of the switching control signal V_{Q} is less than the first predetermined time value or whether the off time (such as logic low level time, marked as Toff) of the switching control signal V_{Q} is greater than the second predetermined time value according to the DC input voltage Vin and DC output voltage Vout. When the on time Ton is less than the first predetermined time value (or the off time Toff is greater than the second predetermined time value), the selection signal SEL is used to select the current reconstruction signal Isum as the detection signal Isel, and when the on time Ton is greater than or equal to the first predetermined time value (or the off time Toff is greater than the second predetermined time value), the selection signal SEL is to select inductor current detection signal Isen as the detection signal Isel; of course, other alternative implementation methods are also possible. For example, the judgment module 23 can be configured to determine whether the off time (marked as Toff) of the switching control signal V_{Q} is greater than the second predetermined time value according to the DC input voltage Vin and the DC output voltage Vout. If the off time Toff is greater than the second predetermined time value, the selection signal SEL is to select the current reconstruction signal Isum as the detection signal Isel. If the off time Toff is less than or equal to the second predetermined time value, the selection signal SEL is to select the inductor current detection signal Isen as the detection signal Isel. The two methods can achieve the same technical effect. It should be noted that in the following text, the technical solution of the present application will only be presented by way of judging the on time Ton of the switching control signal V_{Q} to generate the selection signal SEL. However, the selection signal SEL can also be generated by way of judging the off time Toff of the switching control signal V_{Q}. In this case, only corresponding equivalent settings need to be made.

By the above settings, the embodiments of the present application can select the appropriate sources of the detection signal Isel under different duty cycle conditions, avoiding the situation where the accurate information of the valley value of the inductor current IL cannot be obtained in time during the off period of the main switch transistor Q1 when the off time of the main switch transistor Q1 is short, causing deviation of the reconstructed current. This enables accurate acquisition of the inductor current information of the system under different duty cycles of the switching control signal V_{Q}, facilitating accurate control of the system and improving output quality. As for the manner of judging according to the sampling of DC input voltage Vin and DC output voltage Vout, since the system is equipped with input and output capacitors at the input and output terminals, the sampled signal can have good stability even during the dynamic changes of the system, and it is not affected by the system off time, making subsequent comparison and control more accurate and controllable. Compared with using dynamic signals, the control is more stable and accurate, and it is easier to simplify the structure of the judgment module 23, making it easier to implement.

Optionally, in some embodiments, when the power converter 20 adopts a fixed frequency control mode, the switching control signal V_{Q} of the power converter 20 has a fixed switching cycle. At this time, the judgment module 23 specifically obtains the conversion ratio of the power converter 20 (i.e., Vout/Vin) according to the DC input voltage Vin and the DC output voltage Vout. It can be understood that in the BUCK topology, the conversion ratio Vout/Vin represents the duty cycle of the switching control signal V_{Q}, so as to judge whether the on time Ton of the switching control signal V_{Q} is less than the first predetermined time value or whether the off time Toff of the switching control signal V_{Q} is less than the second predetermined time value according to the conversion ratio Vout/Vin.

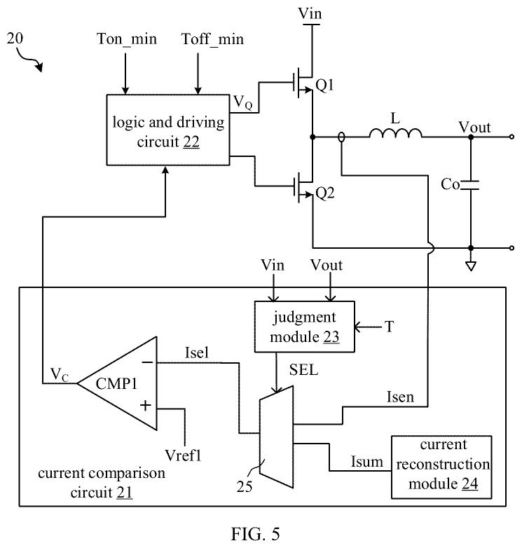

In some other embodiments, when the power converter 20 adopts the variable frequency control mode, the switching control signal V_{Q} of the power converter 20 has a changing switch cycle. Refer to FIG. 5, FIG. 5 shows a schematic diagram of structure of another power converter provided in the present embodiment. In the example shown in FIG. 5, the power converter 20 has a structure that is basically the same as that in FIG. 4, and the similarities will not be repeated. The difference is that in the example shown in FIG. 5, the judgment module 23 not only receives the DC input voltage Vin and the DC output voltage Vout, but also receives a signal representing the switching cycle T of the switching control signal V_{Q}; at this time, the judgment module 23 specifically obtains the conversion ratio Vout/Vin of the power converter 23 according to the DC input voltage Vin and the DC output voltage Vout, and then determines whether the on time Ton of the switching control signal V_{Q} is less than the first predetermined time value or whether the off time Toff of the switching control signal V_{Q} is less than the second predetermined time value according to the conversion ratio Vout/Vin and the switching cycle T. From the on time Ton=(Vout/Vin)*T of the switching control signal V_{Q}, i.e. Ton=(Vout/Vin)*(1/f), it can be obtained that in this embodiment, the actual on time Ton or off time Toff of the switching control signal V_{Q} in each switching cycle can be calculated according to the conversion ratio Vout/Vin and the switching cycle T, so further by comparing the on time Ton or the off time Toff with the corresponding preset value, it is possible to accurately determine whether the on time Ton or off time Toff of the switching control signal V_{Q} is less than the corresponding preset time value even in the case of frequency changes in the power converter 20, and make accurate selection of the detection signals Isel's according to this. In this way, it can make the proposed solution be applied more extensive. Of course, the power converter solution shown in FIG. 5 is also applicable in the case of fixed frequency control.

In some preferred examples, the logic and drive circuit 22 also receives a minimum on-time signal Ton_min and a minimum off time signal Toff_min, which are used to jointly output a switching control signal V_{Q} according to the comparison signal Vc output by the current comparison circuit 21, the minimum on-time signal Ton_min, and the minimum off time signal Toff_min. At this time, the selection signal SEL output by the judgment module 23 is also used to enable the minimum off time limit mechanism of the switching control signal V_{Q} when the on time Ton is less than the first predetermined time value or the off time Toff is greater than or equal to the second predetermined value. That is, the logic and driving circuit 22 is trigged to switch the logic level state of the switching control signal V_{Q} only after the off time Toff of the switching control signal V_{Q} reaches the minimum off time signal Toff_min, to avoid the problem of insufficient off time Toff caused by sudden changes in the duty cycle of the switching control signal V_{Q}, so as to ensure the accuracy of the average current of the system; alternatively, the selection signal SEL output by the judgment module 23 is also used to enable the minimum on time limit mechanism of the switching control signal V_{Q} when the on time Ton is greater than or equal to the first predetermined time value, or the off time Toff is less than the second predetermined value, that is, the logic and driving circuit 22 is trigged to only switch the logic level state of the switching control signal V_{Q} after the on time Ton of the switching control signal V_{Q} reaches the minimum on time signal Ton-min. This avoids the problem of insufficient on time Ton caused by sudden changes in the duty cycle of the switching control signal V_{Q} to a very small value, ensuring that the system does not trigger incorrectly when comparing peak currents and providing accurate control of the system.

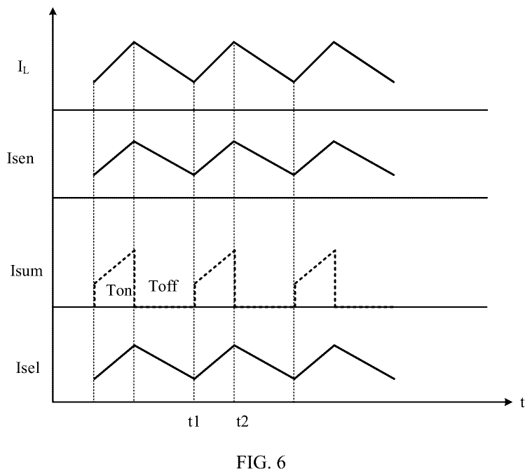

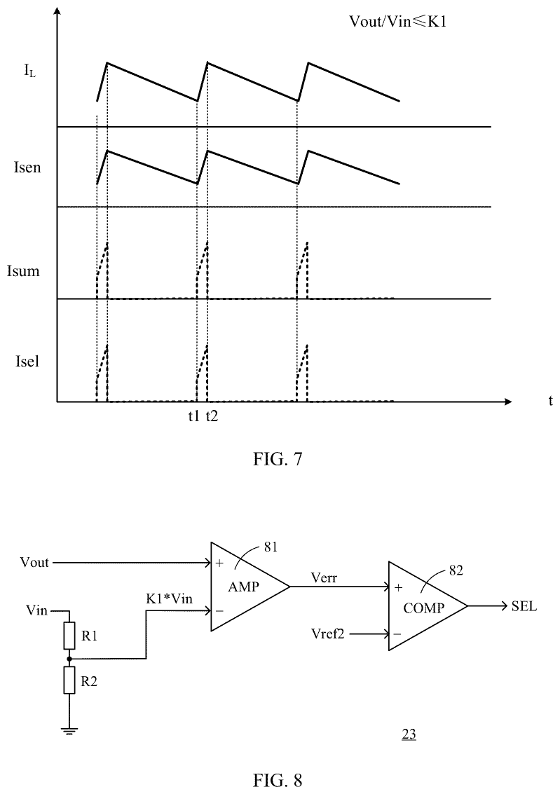

Furthermore, the judgment module 23 in the power converter 20 is executed as, e.g., a comparison module, to determine whether the conversion ratio Vout/Vin of the power converter 20 is less than a preset value (marked as K1) according to the relationship between the DC input voltage Vin and the DC output voltage Vout, thereby determining whether the on time Ton of the switching control signal V_{Q} is less than the first predetermined time value. Exemplarily, when the comparison module detects that the conversion ratio Vout/Vin is greater than the preset value K1, i.e. Vout/Vin≤K1, it can be determined that the on time Ton of the switching control signal V_{Q} is greater than or equal to the first predetermined time value (or it can be determined that the off time Toff of the switching control signal V_{Q} is less than the second predetermined time value). Refer to FIG. 6, at this time, the selector 25 selects the inductor current detection signal Isen as the detection signal Isel according to the selection signal SEL; when the comparison module detects that the conversion ratio Vout/Vin is less than or equal to the preset value K1, i.e., Vout/Vin≤K1, it can be determined that the on time Ton of the switching control signal V_{Q} is less than the first predetermined time value (or the off time Toff of the switching control signal V_{Q} is greater than or equal to the second predetermined time value). At this time, refer to FIG. 7, the selector 25 selects the current reconstruction signal Isum as the detection signal Isel according to the selection signal SEL.

In specific implementation, FIG. 8 shows a block diagram of structure of the judgment module provided in the first embodiment of the present application. In the example shown in FIG. 8, the aforementioned comparison module (i.e. judgment module) 23 comprises a first resistor network, an error amplifier 81, and a second comparator 82.

Wherein, the first resistor network comprises resistors R1 and R2 connected in series between the DC input voltage Vin and the reference ground, which are used to obtain the proportional signal of the DC input voltage Vin according to a predetermined proportional coefficient (i.e., the voltage division coefficient of resistors R1 and R2, equal to R2/(R1+R2)). The proportional coefficient is equal to the predetermined value K1 of the conversion ratio, that is, the proportional signal of the DC input voltage Vin is equal to K1*Vin. The positive input terminal of error amplifier 81 receives the DC output voltage Vout. The negative input terminal of error amplifier 81 is connected to the output terminal of the first resistor network (i.e., the connection node between resistor R1 and resistor R2). Error amplifier 81 is used to amplify the error between the DC output voltage Vout and the proportional signal of the DC input voltage Vin (i.e. K1*Vin) to generate an error signal Verr. The second comparator 82 is used to compare the error signal Verr output by the error amplifier 81 with the second reference voltage Vref2 to generate the selection signal SEL.

according to the working principle of the error amplifier and the comparator, it can be seen that in the example shown in FIG. 8, when the DC output voltage Vout received at the positive input terminal of the error amplifier 81 is greater than the proportional signal of the DC input voltage Vin received at its negative input terminal (i.e., Vout>K1*Vin), the error signal Verr output by the error amplifier 81 is greater than the second reference voltage Vref2 and indicates that Vout/Vin>K1. At this time, the judgment module 23 can judge that the conversion ratio Vout/Vin is greater than the preset value K1, and thus judge that the on time Ton of the switching control signal V_{Q} is greater than or equal to the first predetermined time value (or judge that the off time Toff of the switching control signal V_{Q} is less than the second predetermined time value), and output a selection signal with a first level state SEL;

When the DC output voltage Vout received at the positive input terminal of the error amplifier 81 is less than or equal to the proportional signal of the DC input voltage Vin received at its negative input terminal (i.e. Vout≤K1*Vin), the error signal Verr output by the error amplifier 81 is less than the second reference voltage Vref2 and indicates that Vout/Vin≤K1. At this time, the judgment module 23 can judge that the conversion ratio Vout/Vin is less than or equal to the preset value K1, and thus judges that the on time Ton of the switching control signal V_{Q} is less than the first predetermined time value (or judge that the off time Toff of the switching control signal V_{Q} is greater than or equal to the second predetermined time value), and outputs a selection signal SEL with a second level state.

In this embodiment, the second reference voltage Vref2 is greater than or equal to zero voltage, and it is preferred that the second reference voltage Vref2 is greater than zero voltage. It can be understood that in the case where the second reference voltage Vref2 is greater than zero voltage, the difference between the second reference voltage Vref2 and zero voltage can effectively increase the predetermined value K1 of the conversion ratio, thereby achieving hysteresis control of the comparison module and avoiding system oscillation caused by repeated switching of the logic level state of the selection signal SEL at the critical point.

It can be understood that the first resistor network and error amplifier 81 in this embodiment constitute the error amplification structure of the comparison module 23, such that the error signal Verr output by the error amplifier 81 can be used to characterize the conversion ratio Vout/Vin of the power converter 20. However, the method shown in this embodiment, which obtains the conversion ratio Vout/Vin of the power converter 20 by performing error amplification on the DC output voltage Vout to the proportional signal of the DC input voltage Vin (i.e. K1*Vin), is easier to implement in practical operation, and the circuit structure is simpler and the implementation cost is lower; the second comparator 82 is a conversion ratio comparison structure connected to the aforementioned error amplification structure. By this two-stage structure, the conversion ratio comparison function of the comparison module 23 is well implemented, and hysteresis comparison can also be achieved.

In specific implementation, FIG. 9 shows a block diagram of structure of the judgment module provided in the second embodiment of the present application. In the example shown in FIG. 9, the aforementioned comparison module (i.e. judgment module) 23 comprises a divider 91 and a third comparator 92.

Wherein, the first input terminal of divider 91 receives the DC output voltage Vout, and the second input terminal of divider 91 receives the DC input voltage Vin. Divider 91 is used to divide the DC output voltage Vout by the DC input voltage Vin to obtain a voltage signal Vk representing the proportionality coefficient between the DC output voltage Vout and the DC input voltage Vin; the positive input terminal of the third comparator 92 receives the voltage signal Vk, and the negative input terminal of the third comparator 92 receives the third reference voltage Vref3. The third comparator 92 is used to compare the voltage signal Vk representing the proportional coefficient with the third reference voltage Vref3 to generate the selection signal SEL.

When the voltage signal Vk representing the proportional coefficient is greater than the third reference voltage Vref3, the judgment module 23 can determine that the conversion ratio Vout/Vin is greater than the preset value K1, thereby determining that the on time Ton of the switching control signal V_{Q} is greater than or equal to the first predetermined time value (or determining that the off time Toff of the switching control signal V_{Q} is less than the second predetermined time value), and outputs a selection signal SEL with a first level state; when the voltage signal Vk representing the proportional coefficient is less than or equal to the third reference voltage Vref3, the judgment module 23 can determine that the conversion ratio Vout/Vin is less than or equal to the preset value K1, thereby determining that the on time Ton of the switching control signal V_{Q} is less than the first predetermined time value (or determining that the off time Toff of the switching control signal V_{Q} is greater than or equal to the second predetermined time value), and outputs a selection signal SEL with a second level state.

It can be understood that in the example shown in FIG. 9, the use of a divider can intuitively reflect the proportional relationship between the DC output voltage Vout and the DC input voltage Vin, that is, the conversion ratio relationship, so that a more accurate selection signal SEL can be obtained when comparing the voltage signal Vk representing the proportional coefficient with the third reference voltage Vref3.

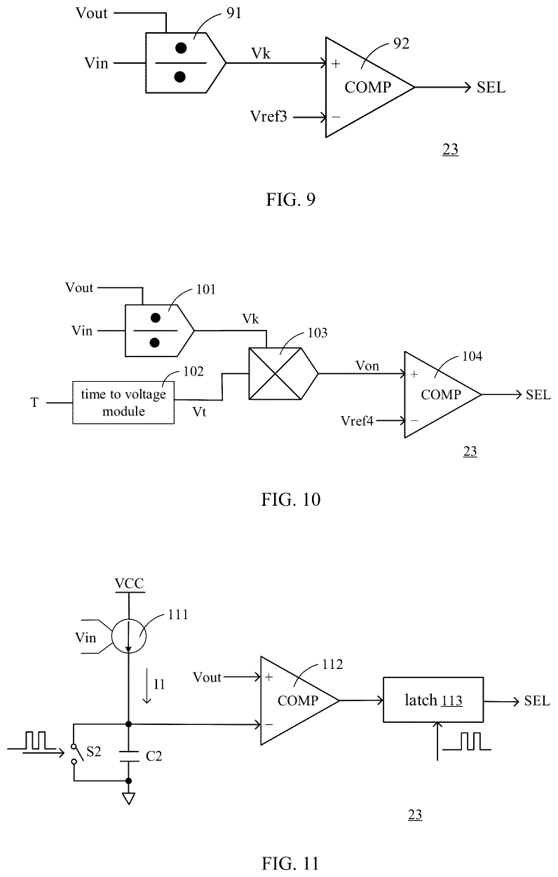

In specific implementation, FIG. 10 shows a block diagram of structure of the judgment module provided in the third embodiment of the present application. In the example shown in FIG. 10, the aforementioned comparison module (i.e. judgment module) 23 comprises: a divider 101, a time to voltage module 102, a multiplier 103, and a fourth comparator 104.

Wherein, the first input terminal of the divider 101 receives the DC output voltage Vout, and the second terminal of the divider 101 receives the DC input voltage Vin; the divider 101 is used to divide the DC output voltage Vout by the DC input voltage Vin to obtain voltage signal Vk representing the proportion coefficient between the DC output voltage Vout and the DC input voltage Vin; the time to voltage module 102 receives a signal of the switching cycle T of the switching control signal V_{Q}, which is used to convert the switching cycle T of the switching control signal V_{Q} into a voltage signal Vt representing the switching cycle; the first input terminal of the multiplier 103 is connected to the output terminal of the divider 101 to receive the voltage signal Vk representing the proportional coefficient; the second input terminal of the multiplier 103 is connected to the output terminal of the time to voltage module 102 to receive the voltage signal Vt representing the switching cycle; the multiplier 103 is used to multiply the voltage signal Vk representing the proportional coefficient with the voltage signal Vt representing the switching cycle to obtain a voltage signal Von representing the on time Von; the first input terminal of the fourth comparator 104 receives the voltage signal Von representing the on time output by the multiplier 103, and the second input terminal of the fourth comparator 104 receives the fourth reference voltage Vref4. The fourth comparator 104 is used to compare the voltage signal Von representing the on time with the fourth reference voltage Vref4 to generate the selection signal SEL.

This embodiment, through the mutual cooperation of the divider 101, time to voltage module 102, and multiplier 133, obtains the voltage signal Von representing the on time according to the DC output voltage Vout, DC input voltage Vin, and the switching cycle T of the switching control signal V_{Q}, and this is equivalent to adding clock cycle correction in the process of obtaining the voltage signal Von representing the on time, which can obtain a more accurate voltage signal Von representing the on time, and thus the judgment module 23 can make more accurate judgments on the relationship between the on time Ton of the switching control signal V_{Q} and the first predetermined time value.

In specific implementation, FIG. 11 shows a block diagram of structure of the judgment module provided in the fourth embodiment of the present application. In the example shown in FIG. 11, the aforementioned comparison module (i.e. judgment module) 23 comprises a voltage controlled current source 111, a capacitor C2, a switch S2, a fifth comparator 112, and a latch 113.

Wherein, the voltage controlled current source 111 and the capacitor C2 are connected in series between the power supply voltage VCC and the reference ground. The voltage controlled current source 111 is used to convert the DC input voltage Vin into an output current I1 and charge the capacitor C2; switch S2 and capacitor C2 are connected in parallel with each other, and switch S2 is controlled by a predetermined clock signal to periodically discharge capacitor C2, so as to generate a proportional signal of the DC input voltage on capacitor C2; the positive input terminal of the fifth comparator 112 receives the DC output voltage Vout, and the negative input terminal of fifth comparator 122 is connected to the intermediate node of capacitor C2 and the voltage controlled current source 111 to receive the proportional signal of the DC input voltage. The fifth comparator 112 is used to compare the DC output voltage Vout with the proportional signal of the DC input voltage generated on the capacitor C2 to generate a selection signal SEL; the latch 113 is connected to the output terminal of the fifth comparator 112 to latch the selection signal SEL under the control of the clock signal.

This embodiment provides another implementation circuit scheme for the judgment module 23, which uses the current signal (i.e. output current I1) to feedback the conversion ratio Vout/Vin information of the power converter 20. It can be understood that when the DC output voltage Vout and the voltage on the capacitor C2 (i.e. the voltage change of the capacitor C2 during the off period of switch S2), since the voltage change of the capacitor C2 during the off period of the switch S2 is positively correlated with the output current I1, and the output current I1 is positively correlated with the input voltage Vin, the voltage on the capacitor C2 is equivalent to a sampling voltage signal proportional to the DC input voltage Vin. That is to say, this embodiment equivalently achieves to determine whether the converter proportion Vout/Vin of power converter 20 is less than the predetermined value by comparing the DC output voltage Vout and the voltage on the capacitor C2.

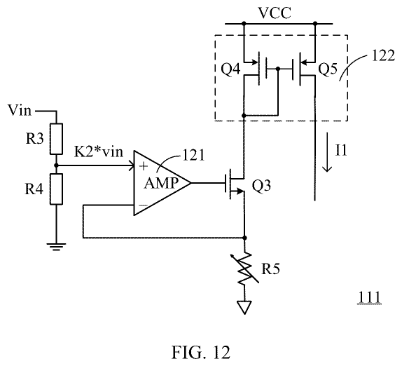

FIG. 12 shows a block diagram of structure of the voltage controlled current source 111. In the example shown in FIG. 12, the voltage controlled current source 111 comprises a second resistor network, an operational amplifier 121, a transistor Q3, a resistor R5, and a current mirror 122.

Wherein, the second resistor network comprises resistors R3 and R4 connected in series between the DC input voltage Vin and the reference ground, which are used to obtain the proportional signal of the DC input voltage Vin; the proportional signal of the DC input voltage Vin obtained by the second resistor network is equal to K2*Vin (the proportional coefficient K2 is a voltage division coefficient of resistors R3 and R4, equal to R4/(R3+R4)); current mirror 122 comprises transistor Q4 and transistor Q5, which are respectively located on the first and second current paths coupled to each other of the current mirror 122; transistor Q3 and resistor R5 are connected in series at the first current path of the current mirror; the positive input terminal of operational amplifier 121 receives the proportional signal of the DC input voltage Vin obtained by the second resistor network (i.e. K2*Vin). The negative input terminal of operational amplifier 121 is connected to the intermediate node between transistor Q3 and resistor R5. The output terminal of operational amplifier 121 is connected to the control terminal of transistor Q3. The second current path of current mirror 122 provides the output current I1 of voltage controlled current source 111.

Furthermore, the resistance value of resistor R5 is equal to the resistance value of the configured resistor of power converter 20, and the configured resistor is used to set the operation switching cycle of power converter 20.

It can be understood that resistor R5 in this embodiment is an adjustable resistor, which can generate corresponding effective resistance value changes in response to the frequency changes of the system. That is to say, when the resistance value of the configured resistor of the power converter 20 changes, the effective resistance value of the resistor R5 will also change accordingly. Therefore, the resistance value change of the resistor R5 can be used to characterize the changes in the system frequency of the power converter 20 (i.e., the frequency of the switching control signal V_{Q}), that is, it can be used to characterize the changes in the switching cycle T of the switching control signal V_{Q}. Wherein, when the proportional signal of the DC input voltage Vin obtained by the second resistor network is constant, the higher the frequency of the system, the larger the resistance of resistor R5, and the smaller the output current I1.

according to the virtual short characteristic of the operational amplifier, it can be known that the operational amplifier 121 and the transistor Q3 form a feedback regulation system, which can generate a voltage signal equal to the proportional signal of the DC input voltage obtained by the second resistor network (i.e. K2*Vin) at both ends of resistor R5. Therefore, according to Ohm's law, a current signal can be generated on the resistor R5 that related to K2*Vin and the system frequency. Through the current mirror 122, the output current I1 related to K2*Vin and the system frequency can be output; that is to say, by using the voltage controlled current source 111 in this embodiment, it is possible to obtain the output current I1 that simultaneously characterizes the proportional signal of the DC input voltage as well as the system frequency. This enables the judgment module 23 in the example shown in FIG. 11 to achieve compatible applications in both fixed frequency and variable frequency control scenarios with a simple structure, and the implementation cost is lower with an increased application scope.

It should be noted that in the above text, only the BUCK topology power converter is used as an example to illustrate the circuit principle of this application. However, the present application is not limited to this, and can be applied to any topology of power converters with voltage loops, such as power converters selected from BOOST topology, BUCK topology, BUCK-BOOST topology, and FLYBACK topology. Wherein, in the BOOST topology, due to the system duty cycle, D=(Vout−Vin)/Vout=1−Vin/Vout, that is to say, there is a positive correlation between the aforementioned conversion ratio Vout/Vin and the duty cycle of the switching control signal V_{Q}.

Finally, it should be noted that the above embodiments are only examples provided to clearly illustrate the present application, and are not limitations on the implementation methods. For those of ordinary skill in the art, other different forms of changes or modifications can be made according to the above explanation. It is not necessary and impossible to exhaustively list all implementation methods here. The obvious changes or variations derived from this are still within the protection scope of the present application.

What is claimed is:

1. A current comparison circuit for a power converter, comprising:
a judgment module, used to generate a selection signal according to a DC input voltage and a DC output voltage of the power converter;
a current reconstruction module, used to generate a current reconstruction signal with a predetermined slope;
a selector, used to select one of an inductor current detection signal of the power converter or the current reconstruction signal as a detection signal according to the selection signal; and
a first comparator, used to compare the detection signal with a first reference voltage to generate a comparison signal,
wherein, the comparison signal is used to adjust duty cycle of a switching control signal of the power converter.

2. The current comparison circuit of claim 1, wherein the judgment module determines whether the on time of the switching control signal is less than a predetermined time value according to the DC input voltage and the DC output voltage,
when the on time is less than the predetermined time value, the selection signal is used to select the current reconstruction signal as the detection signal,
when the on time is greater than or equal to the predetermined time value, the selection signal is used to select the inductor current detection signal as the detection signal.

3. The current comparison circuit of claim 2, wherein the switching control signal has a fixed switching cycle, the judgment module obtains a conversion ratio of the power converter according to the DC input voltage and the DC output voltage, and determines whether the on time of the switching control signal is less than a predetermined time value according to the conversion ratio.

4. The current comparison circuit of claim 2, wherein the switching control signal has a varied switching cycle, the judgment module obtains a conversion ratio of the power converter according to the DC input voltage and the DC output voltage, and determines whether the on time of the switching control signal is less than a predetermined time value according to the conversion ratio and the switching cycle.

5. The current comparison circuit of claim 2, wherein when the on time is less than the predetermined time value, the selection signal is further used to enable the minimum off time limit of the switching control signal,
when the on time is greater than or equal to the predetermined time value, the selection signal is also used to enable the minimum on time limit of the switching control signal.

6. The current comparison circuit of claim 2, wherein the judgment module comprises:
a comparison module, used to determine whether the conversion ratio of the power converter is less than a predetermined value according to the relationship between the DC input voltage and the DC output voltage.

7. The current comparison circuit of claim 6, wherein the comparison module comprises:
a first resistor network, used to obtain a proportional signal of the DC input voltage according to a predetermined proportional coefficient, and the proportional coefficient is equal to a predetermined value of the conversion ratio;
an error amplifier, used to amplify an error between the DC output voltage and the proportional signal of the DC input voltage to generate an error signal; and
a second comparator, used to compare the error signal with a second reference voltage to generate the selection signal,
wherein, the second reference voltage is greater than or equal to zero voltage; when the second reference voltage is greater than zero voltage, the second reference voltage is used to increase the predetermined value of the conversion ratio to achieve hysteresis control.

8. The current comparison circuit of claim 6, wherein the comparison module comprises:
a divider, used to divide the DC output voltage by the DC input voltage to obtain a voltage signal representing the proportional coefficient; and
a third comparator, used to compare the voltage signal representing the proportional coefficient with a third reference voltage to generate the selection signal.

9. The current comparison circuit of claim 6, wherein the comparison module comprises:
a divider, used to divide the DC output voltage by the DC input voltage to obtain a voltage signal representing the proportional coefficient;
a time-to-voltage module, used to convert the switching cycle of the switching control signal into a voltage signal representing the switching cycle;
a multiplier, used to multiply the voltage signal representing the proportional coefficient with the voltage signal representing the switching cycle to obtain a voltage signal representing the on time; and
a fourth comparator, used to compare the voltage signal representing the on time with a fourth reference voltage to generate the selection signal.

10. The current comparison circuit of claim 6, wherein the comparison module comprises:
a voltage controlled current source, used to convert the DC input voltage into an output current of the voltage controlled current source;
a capacitor and a switch connected in parallel with each other, the voltage controlled current source is connected to the capacitor to charge the capacitor, and the switch discharges the capacitor periodically under the control of a clock signal, to generate a proportional signal of the DC input voltage on the capacitor;
a fifth comparator, used to compare the DC output voltage with the proportional signal of the DC input voltage generated on the capacitor to generate the selection signal; and
a latch, used to latch the selection signal under the control of the clock signal.

11. The current comparison circuit of claim 10, wherein the voltage controlled current source comprises:
a second resistor network, used to obtain a proportional signal of the DC input voltage;
a current mirror, comprising a first current path and a second current path coupled to each other;
a transistor and a first resistor, connected in series at the first current path of the current mirror; and
an operational amplifier, wherein the positive input terminal of the operational amplifier receives the proportional signal of the DC input voltage obtained by the second resistor network, and the negative input terminal is connected to the intermediate node between the transistor and the first resistor, and the output terminal is connected to the control terminal of the transistor, wherein, the second current path of the current mirror provides the output current of the voltage controlled current source.

12. The current comparison circuit of claim 11, wherein the resistance value of the first resistor is equal to the resistance value of a configuration resistor of the power converter, and the configuration resistor is used to set the operating switching cycle of the power converter.

13. A power converter, wherein comprising:
a power stage circuit;
the current comparison circuit of to claim 1, used to obtain a comparison signal of inductor current, and the comparison signal is used to adjust the duty cycle of the switching control signal of the power converter;
a logic and driving circuit, to receive the comparison signal output by the current comparison circuit, to output a switching control signal according to the comparison signal to control the on/off states of a main switch transistor in the power stage circuit.
